(19) United States
(12) Patent Application Publication
(10) Pub. No.: US 2026/0018636 A1
(43) Pub. Date: Jan. 15, 2026

(54) HIGH-TEMPERATURE PEM FUEL CELL SYSTEM WITH HEAT PUMP FOR HEATING A REFORMER AND METHOD OF ITS OPERATION AS WELL AS USE THEREOF

(71) Applicant: BLUE WORLD TECHNOLOGIES HOLDING APS, Aalborg Oest (DK)

(72) Inventor: Mads BANG, Støvring (DK)

(73) Assignee: BLUE WORLD TECHNOLOGIES HOLDING APS, Aalborg Oest (DK)

(21) Appl. No.: 19/138,446

(22) PCT Filed: Dec. 15, 2023
(86) PCT No.: PCT/DK2023/050315

§ 371 Date: Jun. 12, 2025

(30) Foreign Application Priority Data
Dec. 19, 2022 (DK) PA202201172

(51) Int. Cl. H01M 8/04701; H01M 8/04007; H01M 8/0662; H01M 8/1231

(52) U.S. Cl. CPC H01M 8/04738; H01M 8/04074; H01M 8/0681; H01M 8/1231; H01M 2250/20

(57) ABSTRACT

A reformer in a HT-PEM fuel cell system, is heated by using a heat pump transferring thermal energy from the cooling circuit to the reformer for the catalytic reformation. As the heating of the reformer does not require a reformer-burner that consumes H2 and/or fuel, the H2 gas from the anode exhaust is advantageously recycled to the fuel cell by mixing with syngas. A separation of H2 gas from the anode in, for example by electrochemical separation, exhaust gas leaves an option to collect the remaining CO2 after condensing the water.

### FIELD OF THE INVENTION

The present invention relates to a high-temperature PEM fuel cell system comprising a reformer and a reformer-heater and a method of its operation as well as use thereof. In particular, it relates to a system as described in the preamble of the independent claims.

### BACKGROUND OF THE INVENTION

For feeding fuel cells with hydrogen gas, H2, or hydrocarbons, various options exist, including pressurised H2, methane or alcohols, for example methanol or ethanol. Typical gas fuels for fuel cells include ethane, propane, and natural gas. Alcohol fuel for fuel cells is advantageous in that existing liquid fuel infrastructure for diesel and gasoline to a large extent can be re-used, which includes also transport of the fuel to supply stations and storage of the fuel in a vehicle.

When using methane or alcohols as fuel, it has to be converted into H2 gas. The corresponding reformation reaction in a catalytic reformer is endothermic and requires energy. For supplying such energy by heating the reformer, a reformer-heater is provided in the fuel cell system. Typically, the reformer-heater is a burner that burns fuel for providing thermal energy. The term burner is common in the technical field, irrespective of the burner using a traditional flame or a catalytic consumption of the fuel for producing the necessary thermal energy. As an option, the burner consumes excess H2 gas from the anode exhaust gas of the fuel cell. When using methanol, the temperature for reformation is typically 250° C. The reformer heater adds thermal energy at a rate sufficient for maintaining the reformation process, in particular 49 KJ/mol for the reaction of methanol and water being reformed into CO2 and H2.

The reformation of the fuel produces syngas, which is a mix of gases, including H2 gas, carbon dioxide, CO2, carbon monoxide, CO, and some remains of water, H2O. For fuel cells with Polymer Electrolyte Membranes (PEM) at low temperature, which is below 100° C., why this type of fuel cells is called LT-PEM fuel cells or just PEM fuel cells, the membranes are sensitive to CO gas, so that this is converted into CO2 in a shift reactor prior to the syngas entering the fuel cell. For typical High-Temperature PEM fuel cells, HT-PEM fuel cells, operating at higher temperatures, above 120° C. and even up to 200° C., the system is more robust against CO gas, and a shift reactor can be avoided.

As fuel cells are becoming increasingly attractive for production of electrical power, in particular in vehicles, such as electrically driven automobiles and marine vessels, there is a steady urge to increase the efficiency for power production, where even improvement in the order of a single percentage is attractive. Accordingly, there is a demand for improvements in the technical field.

For example, in US patent publication US2010/0266923A1, an electrochemical hydrogen separator is disclosed for separating H2 gas from a fuel cell anode exhaust gas and re-introduce this into the fuel cell in order to optimize efficiency of the fuel cell. Monitoring of the performance of the hydrogen separation device gives an indication as to the fuel cell system performance. When H2 gas is separated from the anode exhaust gas stream and recycled into the fuel cell anode, it disappears as fuel for the reformer-heater. This is not a problem for SOFC cells working at temperatures in the range of 750° C.950° C., as disclosed in US2010/0266923A1, because the excess heat of the fuel cell can be used for heating not only the electrochemical H2-separator, as illustrated in this disclosure, but also the reformer.

However, for fuel cells operating at lower temperatures, fuel is traditionally used for heating the reformer, so that H2-separation and reintroduction into the anode does not bring about any apparent efficiency advantage.

This consideration is supported by study of the system disclosed in the German patent application DE102013009244A1, in which a membrane-separator is used for separating H2 from the anode gas in order to capture the remaining CO2 in a storage tank after removal of water by condensation. In this reference, membranes are used for transport of H2 out of a gas stream and into an H2O stream for H2-enriching the fuel gas stream for the reformer-heater. This follows the traditional approach of using H2 in the cycle for introduction into a reformer-burner, be it by flame or by catalytic burning, for heating the reformer. As an additional option, DE102013009244A1 discloses H2-enrichment of the methane gas stream that goes into the catalytic reformer. However, in a closer evaluation, this does not appear optimum, as the elevated H2 levels in the gas stream at the inlet of the reformer can be expected to not increase but instead reduce the overall efficiency of the reformation, seeing that the H2 concentration is already offset to a substantial concentration level from the onset in the reformer, so that the additional H2-production capabilities in the reformer up to a maximum concentration of H2 in the gas is not optimised. Accordingly, it is understood from the disclosure in DE102013009244A1 that the separation of H2 from the anode gas exhaust is not motivated by a general objective of increasing the efficiency of the fuel cell system, but the separation is motivated by finding some meaningful use of the separated of H2 gas from the anode exhaust, which is rather a by-product, prior to capturing carbon from the exhaust stream, the carbon capture being the main objective of DE102013009244A1.

However, it would be desirable to find a reformer-heater, different from a reformerburner, for heating the reformer without combustion of H2 gas or other fuel in the reformer-heater, in particular for fuel cell systems in which the fuel cells are operating at a temperature that is lower than the minimum temperature necessary for the reformation.

In the article, “Electrochemical hydrogen pumping using a high-temperature polybenzimidazole (PBI) membrane” published by Perry et al. in Journal of Power Sources 177 (2008) 478-484, electrochemical hydrogen separation from a mix of gases, including N2, H2, CO, and CO2, was disclosed using a high-temperature (>100° C.) polybenzimidazole (PBI) membrane. In particular, the electrochemical pump was operated at 160° C. on approximately 1.2 times that of the stoichiometric requirements of pure hydrogen without external humidification. It is pointed out that such a hydrogen pump is operated at a temperature of 160° C., which is similar to the coolant temperature of HT-PEM fuel cell, whereas the coolant from a LT-PEM fuel cell, such as disclosed in the above-mentioned DE102013009244A, would be below 100° C. and, thus, not deliver a sufficiently high temperature. EP1081781A2 discloses a multi-stage chemical heat pump HP1+HP2 for removing heat and maintaining the solid polymer electrolyte fuel cell at a temperature of 80° C. and raise the temperature of the heat carrier to 350° C., which can be used to heat the reformer. The high increase in temperature from 80° C. to 200° C. in HP1 and to 350° C. in HP2 is desired in order to have an efficient cooling by the radiator, which can then be made smaller, and the hydrogenation reactors can be made compact. The system is suggested used in an automobile. The heat can be used to heat the reformer. However, this system is complex. Additionally, it is also dangerous in an automobile, as IPA, acetone and H2 as well as other chemicals are kept in mixture at more than 200° C. and other chemical at higher temperature.

DE10152233A1 discloses LT-PEM fuel cells, operating at temperatures of 50-120° C. It discusses that operation at 80° C. would require a large air cooler if the outside temperature is 20° C., but can be made smaller when the temperature is raised to 100° C. by the heat pump. The system is suggested used in an automobile. The heat can be used to heat the reformer. However, it is silent with respect to the specific type of the heat pump.

### Description/Summary of the Invention

It is an objective of the invention to provide an improvement in the art. In particular, it is an objective to provide a reformer-heater for a HT-PEM fuel cell system that does not provide heat to the reformer by burning H2 or fuel. This objective and further advantages are achieved with a fuel cell system and a method of its operation as described below and in the claims. In particular, the invention concerns a fuel cell system as described in claim 1 and a method of its operation as described in claim 6.

In short, a fuel cell system is presented in the following, in which a reformer is heated by using a heat pump that is transferring thermal energy from the cooling circuit to the reformer to maintain the reformer at a predetermined temperature T_{ref} that is not lower than a minimum temperature necessary for the catalytic reformation. As the heating of the reformer does not require a reformer-burner that consumes H2 and/or fuel, the H2 gas from the anode exhaust gas is advantageously recycled to the fuel cell by mixing with syngas. A separation of H2 gas from the anode exhaust gas, for example by electrochemical separation, leaves an option to collect the remaining CO2, for example as liquid CO₂, after condensing and removing the water.

Details are explained in the following.

The fuel cell system comprises a fuel supply for providing fuel to a reformer so that the fuel cell can be fed with H2 gas after reformation of the fuel. Examples of gaseous fuels are methane, ethane, propane, natural gas; and examples of liquid fuels are alcohols, such as methanol or ethanol.

The reformer is receiving the fuel, for example after evaporation of liquid fuel, for catalytic reformation of the fuel into H2 gas and other gas by-products, such as CO2, water, and CO. If necessary, the CO may be further converted into CO2 by a shift converter. For HT-PEM fuel cells, however, the removal of CO is, typically, not necessary.

A fuel cell is provided, typically, as part of a stack of fuel cells, which is common practice. The fuel cell has a membrane and an anode side on one side of the membrane and a cathode side on the opposite side of the membrane. In the following, the short terminology of anode and cathode will be used for the fuel cell.

The anode receives the hydrogen gas from the reformer for the reaction in the fuel cell, and the cathode receives oxygen gas, for example as part of air. In PEM fuel cells, the supplied H2 gas traverses the ion-conducting membrane and forms water in the cathode. The water leaves the cathode as steam together with other gaseous components, such as nitrogen from supplied air.

As already discussed in the introduction, if the fuel cell operates at a lower temperature than necessary for the reformation process, the reformer must be heated by a reformerheater to a temperature T_{ref} not lower than a minimum temperature necessary for the catalytic reformation.

The fuel cell is a HT-PEM fuel cell, operating at a temperature in the range of 120-200° C., such as 150-180° C. An example is given in the following where the HT-PEM fuel cell is operated at a temperature around 170° C., which is the temperature of the coolant at the outlet of the coolant channel in the fuel cell stack. Slight variations along the fuel cell stack, however, are normal, so that the operational temperature of the fuel cell stack is typically no more precise than a predetermined temperature+/−10 degrees. For a set operational temperature of 170° C., which is the temperature by which the coolant leaves the fuel cell stack, the fuel cell stack would have temperature variations in the range of 160-180° C. In particular, the coolant that leaves the fuel cell at T2=170° C. would enter the fuel cell stack at a lower temperature T1, for example T1=160° C., which is one of the reasons for the temperature variations within the stack.

The minimum temperature for the reformation of methanol is around 200° C., but for reformation at a sufficient speed, the operation temperature for the reformer is higher. The predetermined reformer temperature T_{ref} for the reformation of methanol is in the range of 250° C.-300° C., and a temperature of T_{ref}=250° C. is sufficient.

In contrast to the prior art, the reformer-heater in the system presented herein comprises an electrically driven heat pump for providing the necessary high temperature. A heat pump does not burn fuel or recycled heat gas. Instead, electricity is consumed, for example as produced by the fuel cell. This way, the driving of the heat pump indirectly consumes H2 due to the necessary additional production of electricity by the fuel cell. However, this has an advantage over reformer-burners as fuel cell are more efficient fuel consumer than reformer-burners. Thus, instead of consuming fuel in the reformerburner at a relatively low efficiency, the fuel is consumed by the more efficient fuel cell. This implies the option of a higher efficiency of the overall system. Additionally, as becomes more apparent in the following, the waste heat from the fuel cell is re-used for the heating of the reformer.

In particular, if H2 is separated from the anode exhaust gas and recycled into the anode, an efficiency increase of several percent can be achieved. This will be explained in more detail below.

By using H2 separation and recycling, an efficiency gain of 7.5% is achieved. When the HT-PEM fuel cells are driven at 170° C., the heat pump can lift the temperature to 250° C. at moderate energy consumption so that the net gain for the system is more than 5%. These estimates include the electrical consumption by the H2-separator.

The heat pump is thermally connected to the cooling circuit for extracting thermal energy from the coolant and lowering the temperature of the coolant, which is advantageous for the efficiency of the fuel cell system, as the heat is normally a waste product, but is useful in the herein described system. Thermal energy from the coolant downstream of the fuel cell is extracted from the coolant and transferred to a heating fluid in a heating circuit which is connected to the reformer for transferring thermal energy from the heating fluid to the reformer for heating the reformer to a reformer temperature T_{ref}. Taking offset in the lower temperature in the cooling circuit, the temperature of the heating fluid in the heating circuit must be raised by the heat pump to a temperature that is not lower than a minimum temperature necessary for the reformation and which is above the temperature of the coolant.

With reference to the above example of a HT-PEM operating at 170° C. and an example of a temperature T_{ref}=250° C. for the reformation of methanol, the temperature of the heating fluid must be raised to a temperature not lower than 250° C. and rather slightly higher.

Current heat pumps used in systems with LT-PEM fuel cells, operating below 100° C., are not expected to yield an efficiency increase as compared to using reformer-burners.

The heat pump comprises a multi-stage gas piston compressor using a working medium for the heat pumping. The COP for heating the reformer to T_{ref} by the heat pump is not less than 2. Various working media exist, some of the efficient heat pumps using helium a working medium.

Examples of heat pumps that can lift the temperature are found in the commercial market. For example, the company Spilling Technologies® GmbH in Germany produces heat pumps using multi-stage steam compressors in modular design with up to 6 cylinders and being able to heat up to 280° C., with a useful Coefficient of Performance, COP, above 2. For lower temperatures than 250° C., the COP is higher, for example as high as 8 or above for a source temperature of 175° C. to an outgoing temperature of 215° C. For a higher outgoing temperature, such as 250° C., the COP is lower but can be expected to be at 5.

With the current state-of-the-art heat pump technology, it is possible to use heat pumps that can perform the lift of the temperature from T2=170° C. to T_{ref}=250° C., making them useful for methanol reformation and HT-PEM cells, in particular. For such HTPEM systems, where the reformer is heated by using heat pumps, and the H2 gas from the anode is recycled, a total efficiency increase of more than 5% has been found as compared to the current state of the art fuel cell systems in which the reformer is heated by a fuel-burner as reformer-heater. This high beneficial increase of the efficiency is made possible, in particular, because the fuel cell is operating at a relatively high temperature that is below but relatively close to the temperature T_{ref} for the reformation. In these calculations, a COP=5 has been assumed. For a simple scaling, it was found that a COP=4 results in an efficiency gain of 4%, a COP-3 results in an efficiency gain of 3%, and a COP=2 results in an efficiency gain of 2%. Thus, even at lower COP than the expected COP=5, for example a COP in the range of 2 to 4, provides a gain when using a heat pump as compared to when using a burner and when the H2 is recycled to the anode.

Particularly interesting is the use for larger fuel cell systems, such as designed for marine vessels. Also, particular interest is the use for fuel cell systems for stationary power stations with electricity production capacities of at least 1 MW.

Multistage compressor heat pumps of large size can be used so that the efficiency gain relatively quickly balances depreciation of the additional investment. For example, the above-mentioned company Spilling Technologies® GmbH provides heat pumps with capacities in the range of 1 MW to 15 MW, having a weight of 15,000-45,000 kg. Needless to state that such heat pumps require large installations, such as marine vessels, especially container cargo ships, or power plants or large-scale energy storage system, for example discussed in connection with the so-called Power-to-X (PtX) options for converting and storing green energy.

Other possible candidates for heat pumps is among the machines provided by Enerin® Energy Engineering, where the heat pump uses a Stirling cycle with a closed single phase system undergoing compression and expansion by double-acting pistons, with an expected COP of 2.5. The heat pump can lift temperatures by 200 degrees, however, limited to a minimum source temperature of 100° C., which makes it suitable for HTPEM but not for LT-PEM. The heat supply capacity is in the range of 0.3 MW to 10 MW, having a weight of 10,000 kg.

In the fuel cell system presented herein, a flow of coolant through the fuel cell is provided with the coolant entering the fuel cell being at a first temperature T1, for example 160° C., and leaving the fuel cell at a second increased temperature T2, for example 170° C., which is higher than the first temperature T1. In order to maintain stable and optimum operation temperature of the fuel cell, the heat pump, which receives the coolant downstream of the fuel cell should not lower the temperature of the coolant at the downstream end of the heat pump system to a temperature T3 below T1. This can be achieved by proper adjustment of the flow and design of the heat pump, for example by selecting heat pumps with proper specs as discussed above.

For the example of the fuel cell system comprising a reformer for reformation of alcohol, such as methanol, the methanol is mixed with water and supplied as evaporated steam to the reformer. The heat for the evaporation is advantageously taken from the coolant in the coolant circuit. For example, the necessary thermal energy can be taken at the low-temperature branch of the cooling circuit, where the temperature is closer to the coolant temperature T1 that is fed into the fuel cell, for example 160° C., or the necessary thermal energy can be taken at the high temperature branch in the cooling circuit with the coolant temperature T2 at the exit of the fuel cell, for example T2=170° C. Having in mind that the heat pump has to lift the temperature to the reformation temperature T_{ref}, for example 250° C., it is better to feed the heat pump with the coolant having the highest available temperature. The consequence is that the evaporator has to be connected in the low temperature branch of the cooling circuit, downstream of the location where the heat pump system takes thermal energy from the cooling circuit.

However, in this case, as the evaporator takes up heat from the coolant, the coolant coming from the heat pump having a temperature T3 at the inlet of the evaporator should have a temperature T3 slightly higher, for example 2-4 degrees higher, than the coolant temperature T1 that is used at the cooling inlet of the fuel cell. Accordingly, when using an evaporator, the heat pump should lower the temperature of the coolant, for example from the level T2, to a temperature T3 that is higher than T1, at which the coolant is fed into the fuel cell.

As the consequence of using a heat pump is a lack of need of H2 gas and other fuel for a reformer burner, the H2 gas can be captured from the anode exhaust gas and recycled into the anode. Accordingly, for the separation, an H2-separator is connected to a downstream side of the anode for receiving the anode exhaust gas and for separating H2 gas from the anode exhaust gas. The hydrogen separator is then on its downstream side connected to a conduit between a downstream side of the reformer and an upstream side of the anode for feeding the separated H2 gas back to the anode after mixing with syngas from the reformer.

In this connection, a comparison should be made with the above-mentioned reference DE102013009244A1, for which it is observed that the only example of direct recycling of H2 into the anode is illustrated in FIG. 3 of DE102013009244A1, in which, however, the anode does not receive syngas, in contrast to the system described herein. Instead, in DE102013009244A1, a recycled H2O steam with the recycled H2 receives additional H2 from the syngas across an H2-separating membrane, and the resulting H2-enriched recycled steam is used for feeding not only the anode but also the reformer-burner after a splitting of the flow into respective separate conduits. This is a different system with different function than the one described herein.

In comparison, in the HT-PEM system described herein with the electrically driven heat pump system instead of a reformer-burner, the H2-separator is only working on the anode exhaust gas and not on the syngas from the reformer, which is in contrast to DE102013009244A1. Accordingly, the necessary capacity of the H2-separator in the system as described herein can be designed much smaller than the H2 membrane-separator in DE102013009244A1. This is another advantage over DE102013009244A1.

In contrast to an LT-PEM fuel cell, for example disclosed in the above-mentioned reference DE102013009244A1, there is no need for a high concentration of H2O steam in the gas supply to the anode of a HT-PEM fuel cell. Accordingly, the principle of DE102013009244A1 of using a recycled stream of H2O steam on one side of a H2-separation membrane for forcing transport of H2 across the H2-separation membrane does not appear useful for HT-PEM fuel cell systems, and high concentration of steam is even not desired because it may even be detrimental to the functioning of the HTPEM fuel cells, in particular the catalysts used therein.

Instead, it has been found, that electrochemical separation of hydrogen gas is better than the membrane separation system of DE102013009244A1.

As an option for electrochemical separation of hydrogen gas, a hydrogen pump as H2-separator can be used of the type as disclosed in the article, “Electrochemical hydrogen pumping using a high-temperature polybenzimidazole (PBI) membrane” published by Perry et al. in Journal of Power Sources 177 (2008) 478-484 and references therein. As already mentioned in the introduction, this article discloses electrochemical hydrogen separation from a mix of gases, including N2, H2, CO, and CO2, was disclosed using a high-temperature (>100° C.) polybenzimidazole (PBI) membrane. In particular, the electrochemical pump was operated at 160° C. on approximately 1.2 times that of the stoichiometric requirements of pure hydrogen without external humidification. Relatively low voltages, less than 1 V, were required to operate the hydrogen pump over a wide range of hydrogen flow rates.

It is pointed out that such a hydrogen pump is operated at a temperature of 160° C., which is similar to the coolant temperature of HT-PEM fuel cell, whereas the coolant from a LT-PEM fuel cell, such as disclosed in the above-mentioned DE102013009244A, would be below 100° C. and, thus, not deliver a sufficiently high temperature.

A pronounced advantage of electrochemical H2 separation, in contrast to a passive membrane, such as in DE102013009244A, is the possibility of monitoring of the performance of the H2-separator, in particular the electricity consumption, which gives an indication of the fuel cell system performance. In some embodiments of the invention described herein, such monitoring of the performance of the fuel cell system is done.

For example, the H2 production can be monitored and the fuel feed lambda value determined.

As alternatives to electrochemical separation, Pressure Swing Adsorption techniques or amine absorption can be useful for the H2-separation.

Having separated H2 from the anode exhaust gas by the H2-separator, and after removal of water, typically by condensation, the remaining gas contains almost exclusively CO2, which can be liquefied and stored in tanks as a carbon capturing measure.

As mentioned above, HT-PEM fuel cells are advantageous in that they are robust against CO in the gas from the reformer so that a shift gas reactor can be avoided. As a consequence, relatively small and lightweight reformers can be used, which is an advantage for minimization of the heat consumption for the reformation process and the corresponding dimensioning of the heat pump system. Accordingly, although heat pumps may be advantageous from different perspectives for various types of fuel cell systems, it appears that, in particular, HT-PEM fuel cell systems can benefit from using heat pumps for the heating of the reformer.

### SHORT DESCRIPTION OF THE DRAWINGS

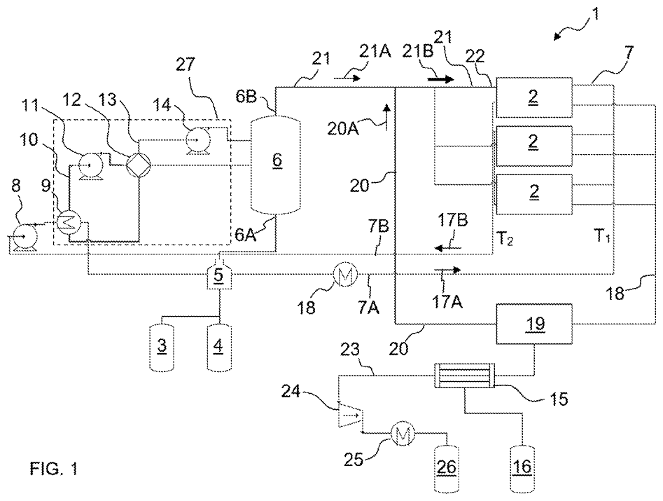

The invention will be explained in more detail with reference to the drawing, where FIG. 1 is an overview sketch of the fuel cell system.

### DETAILED DESCRIPTION/PREFERRED EMBODIMENT

FIG. 1 illustrates a fuel cell system 1 comprising a plurality of fuel cells 2, typically arranged in parallel as a fuel cell stack, as illustrated. Methanol as fuel from a fuel tank 3 in combination with water from a water tank 4 are mixed and evaporated in an evaporator 5. The evaporated mix of methanol and water is fed into an inlet 6A of a catalytic reformer 6, which produces syngas as reformate. Such syngas contains carbon dioxide, CO2, carbon monoxide, CO, and hydrogen gas, H2, as well as some remains of water. The syngas is fed from the reformate outlet 6B, as indicated by arrow 21A, into an inlet 22 of the anode of the fuel cell 2, and H2 is used for production of electricity by the fuel cell 2.

The fuel cell 2 is a HT-PEM fuel cell, which is not sensitive to CO and which does not need a shift reactor and neither a high water steam content in the syngas, in contrast to LT-PEM cells.

As alternative to methanol, other alcohols can be used, for which the reformer temperature would have to be correspondingly adjusted.

The HT-PEM fuel cells 2 are by example driven at a temperature in the range of 170° C.180° C., so that the coolant in the cooling circuit 7, pumped towards to the fuel cell stack by coolant pump 8 in directions indicated by arrows 17A and 17B, is heated from T1=160° C. to T2=170° C. It is possible to drive the fuel HT-PEM cells 2 at slightly different temperature in the range of 120° C.-200° C., but typically in the range of 150° C.180° C. Advantageously, the polymer electrolyte membrane PEM in the HT-PEM fuel cell is mineral acid based, typically a polymer film, for example polybenzimidazole (PBI) doped with phosphoric acid.

The reformer 6 is heated by reformer-heater 27, indicated by a stippled line in FIG. 1, the components of which are explained in more detail in the following.

The coolant flowing from the fuel cells 2, as indicate by arrow 17B, at a temperature of T2 from the fuel cells 2 is transferring thermal energy in transfer heat exchanger 9 to a transfer fluid in a transfer circuit 10, in which the transfer fluid is pumped by a transfer pump 11.

The transfer circuit 10 is in thermal connection with an electrically driven heat pump 12. The heat pump 12 transfers thermal energy from the transfer fluid in the transfer circuit 10 to a heating fluid that is circulating in a heating circuit 13, driven by a corresponding heating fluid pump 14, which heats the reformer 6.

An advantage of the transfer circuit 10 is easy adjustment of the entrance temperature into the heat pump 12 and adjustment of the temperature of the coolant in the cooling circuit 7 downstream of the transfer heat exchanger 9.

In the illustrated system, the coolant in the low temperature branch 7A of the cooling circuit 7, downstream of the transfer heat exchanger 9, is used to heat the mix of fuel and water in the evaporator 5, after which the temperature of the coolant should be T1, for example T1=160° C. for maintaining a stable operation temperature of the fuel cells 2. Fine adjustment of the temperature to T1 can be done with an adjustment heat exchanger 18. Depending on the need of heat in the evaporator 5, which varies with load and corresponding fuel consumption by the fuel cells 2, the temperature of the coolant in the cooling circuit 7 can be adjusted by regulating the transfer of thermal energy in the transfer heat exchanger 9 upstream of the evaporator 5. The electricity consumption of the heat pump 12 is adjusted in dependence on the temperature of the transfer fluid in the transfer circuit 10 and the need for heat in the reformer 2.

The heat pump is raising the temperature of the transfer fluid from a temperature in the range of 120° C.-200° C. to a temperature of the heating fluid of at least T_{ref}=220° C., optionally raising the temperature of the transfer fluid from a temperature in the range of 150° C.-180° C. to a temperature of the heating fluid of at least T_{ref}=250° C.

By using a reformer heater 27 as presented herein, which includes the heat exchanger 9, transfer circuit 10 with its pump 11, and the heating circuit 13 with its pump 14, as well as the heat pump 12, no fuel or H2 gas is needed for a reformer-burner, so that the H2 gas that is leftover in the anode exhaust gas conduit 18 can be separated by the H2-separator 19, which is, for example, an electrochemical H2-separator, and fed through H2-conduit 20 into a syngas-conduit 21 that connect the reformate outlet 6B of the reformer 6 with the inlet 22 of the anode of the fuel cell 2. The flow of H2 gas in the H2-conduit 20, as indicated by arrow 20A, downstream of the separator 19 is added to the syngas that is flowing from the reformer (6) in the syngas-conduit 21, as indicated by arrow 21A, and results in a combined flow, as indicated by thickened arrow 21B in syngas-conduit 21 upstream of the anode inlet 22 of the fuel cell 2.

Additionally, as the H2 gas has been separated from the anode exhaust gas in exhaust conduit 18 by the H2-separator 19, the remaining gases, primarily water steam and CO2 gas can, in principle, be discarded. Optionally, however, the water is separated from the CO2 gas in condenser 15 and collected in water reservoir 16, potentially for being reused for mixing with fuel. The remaining CO2 in the CO2-conduit 23 is, optionally, collected as liquid in CO2-tank 26, for example after compression in compressor 24 and condensation in heat exchanger 25.

Notice that the additional elements of H2-separation and H2 recycling into the fuel cell and not into a burner, as well as water recycling and potential carbon capture all benefit from the use of the heat-pump 12 so that the overall result of the addition of these elements is not a mere aggregation but a synergistic combination of elements leading to an overall improved and environmentally friendly system.

I claim:

1. A fuel cell system comprising
a fuel supply for supplying fuel,
a reformer for catalytic reformation of the fuel into syngas containing hydrogen, H2,
a fuel cell having an anode that is flow-connected to a reformate-outlet of the reformer for receiving the syngas and using the H2 for producing electricity,
a reformer-heater for heating the reformer to a predetermined reformer temperature T_{ref} and not lower than a minimum temperature necessary for the catalytic reformation of the fuel, and
a cooling circuit containing a flow of coolant for maintaining an operation temperature of the fuel cell, which is less than the predetermined reformer temperature T_{ref},
wherein the reformer-heater comprises an electrically driven heat pump that is thermally connected to the cooling circuit for extracting thermal energy from the coolant and lowering the temperature of the coolant and transferring the extracted thermal energy to a heating fluid in a heating circuit for heating the heating fluid and for providing the heating fluid at a temperature not lower than the predetermined reformer temperature T_{ref}, wherein the heating circuit is connected to the reformer for transferring thermal energy from the heating fluid to the reformer, wherein the fuel cell is a HT-PEM fuel cell having an operation temperature in the range of 120° C. ° C., that T_{ref} is in the range of 250° C.300° C., that the heat pump comprises an electrically driven multi-stage gas piston compressor and that the COP for heating the reformer to T_{ref} by the heat pump is not less than 2.

2. The system according to claim 1, wherein the fuel comprises methanol and water, and wherein the system comprises an evaporator for receiving and evaporating the fuel for reformation in the reformer.

3. The system according to claim 1, wherein the system comprises a H2-separator connected to an anode-exhaust conduit downstream of the anode for receiving the anode exhaust gas and for separating H2 from the anode exhaust gas, wherein the H2-separator is flow-connected to a syngas-conduit that connects a reformate-outlet of the reformer to an inlet of the anode for recycling the separated H2 gas into the anode after mixing with syngas from the reformer.

4. The system according to claim 3, wherein the H2-separator is an electrochemical H2-separator.

5. The system according to, claim 3, wherein the system downstream of the H2-separator comprises a water separator for separating water from the anode exhaust gas after H2-sparation and a CO2 liquefier and further a CO2 storage tank for storing the remaining CO2 in liquid form.

6. A method of operating a fuel cell system comprising a fuel cell, wherein the method comprises
heating a catalytic reformer by a reformer-heater to a predetermined reformer temperature T_{ref} not lower than a minimum temperature necessary for catalytic reformation of fuel into syngas containing hydrogen, H2,
maintaining an operation temperature of the fuel cell by a cooling circuit that comprises a flow of coolant, wherein the operation temperature is less than the predetermined reformer temperature T_{ref} by the cooling circuit, and
reforming fuel by the reformer into syngas containing hydrogen, H2, and feeding the syngas into an anode of the fuel cell and producing electricity by the fuel cell by consuming a first portion of the H2, and releasing a second portion of the H2 from the anode as part of an anode exhaust gas;
wherein the reformer heater comprises an electrically driven heat pump which is thermally connected to the cooling circuit and the method comprises driving the heat pump by electricity and extracting thermal energy from the coolant in the cooling circuit and lowering the temperature of the coolant by the heat pump and transferring the extracted thermal energy to a heating fluid in a heating circuit and heating the heating fluid and providing the heating fluid at a temperature not lower than the predetermined reformer temperature T_{ref} and transferring thermal energy from the heating fluid to the reformer;
wherein the fuel cell is a HT-PEM fuel cell and the method comprises operating the fuel cell at a temperature in the range of 120° C. ° C., that T_{ref} is in the range of 250° C. ° C., that the electrically driven heat pump comprises an electrically driven multistage gas piston compressor and wherein the COP for heating the reformer to T_{ref} by the heat pump is not less than 2.

7. The method according to claim 6, wherein the fuel comprises alcohol, and wherein the system comprises a fuel evaporator, wherein the method comprises receiving and evaporating the fuel in the evaporator and feeding the evaporated fuel into the reformer and catalytically reforming the fuel by the reformer to produce gaseous H2, feeding the H2 from the reformer into the anode of the fuel cell.

8. The method according to claim 6, wherein the method comprises providing a flow of coolant through the fuel cell, the coolant entering the fuel cell at a first temperature T1 and leaving the fuel cell at a second increased temperature T2 that is higher than the first temperature T1, and wherein the heat pump receives the coolant after temperature increase to T2 by the fuel cell, and wherein the method comprises extracting thermal energy from the coolant by using the heat pump and lowering the temperature of the coolant to a third temperature T3 that is lower than T2 but not lower than the first temperature T1.

9. The method according to claim 8, wherein the method comprises lowering the temperature of the coolant by the heat pump to a third temperature T3 that is lower than T2 but higher than the first temperature T1, and feeding the coolant downstream of the reformer heater into an evaporator and transferring thermal energy from the coolant to the fuel for evaporation of the fuel in the evaporator prior to the fuel entering the reformer and lowering the temperature from the third temperature T3 to a fourth temperature T4 by this transfer of thermal energy in the evaporator, wherein the fourth temperature T4 is not lower than the first temperature T1.

10. The method according to claim 6, wherein the method comprises providing a hydrogen separator connected to an anode exhaust gas conduit on a downstream side of the anode and receiving the anode exhaust gas and separating H2 gas from the anode exhaust gas by the hydrogen separator and recycling the separated H2 gas into the anode.

11. The method according to claim 10, wherein the method comprises adding the separated H2 gas to the syngas from the reformer in a syngas-conduit that connects a reformate-outlet of the reformer with a gas inlet of the anode of the fuel cell.

12. Use of a system according to claim 1 for producing electricity on an electrically driven marine vessel.

13. Use of a method according to claim 6 for producing electricity on an electrically driven marine vessel.
